(19) United States
(12) Patent Application Publication
(10) Pub. No.: US 2022/0402215 A1
(43) Pub. Date: Dec. 22, 2022

(54) ACRYLIC SUPPORT STRUCTURE FOR 3D PRINTED FLUOROPOLYMER ARTICLE

(71) Applicant: Arkema Inc., King of Prussia, PA (US)

(72) Inventors: David S. LIU, Bala Cynwyd, PA (US); Mary K. CALVIN, Havertown, PA (US); Evan J. FISHER, Malvern, PA (US); Mark A. AUBART, West Chester (US); Jing-Han WANG, Blue Bell, PA (US)

(73) Assignee: Arkema Inc., King of Prussia, PA (US)

(21) Appl. No.: 17/777,546

(22) PCT Filed: Nov. 17, 2020
(86) PCT No.: PCT/US2020/060849

§ 371 Date: May 17, 2022

Related U.S. Application Data
(60) Provisional application No. 62/936,779, filed on Nov. 18, 2019.

(51) Int. Cl. B29C 64/40; B29C 64/112; C08L 33/12; C08L 27/16; C08L 77/00; C08G 65/00

(52) U.S. Cl. CPC B29C 64/40; B29C 64/112; C08L 33/12; C08L 27/16; C08L 77/00; C08G 65/00; B33Y 10/00

(57) ABSTRACT

The use of compatible, semi-miscible or miscible polymer compositions as support structures for the 3D printing of objects, including those made from polyether-block-amide copolymers such as PEBAX® block copolymers from Arkema, polyamides such as RILSAN® polyamides from Arkema, polyether ketone ketone such as KEPSTAN® PEKK from Arkema, and fluoropolymers, such a KYNAR® PVDF from Arkema, especially objects of polyvinylidene fluoride and its copolymers. One particularly useful miscible polymer is an acrylic polymer, which is miscible with the fluoropolymer in the melt. The support structure composition provides the needed adhesion to the build plate and to the printed object and support strength during the 3D printing process, yet it is removable after the fluoropolymer object has cooled. The support polymer composition is selected to be stiff and low warping, yet flexible enough to be formed into filaments.

### FIELD OF THE INVENTION

The invention relates to the use of compatible, semi-miscible or miscible polymer compositions as support structures for the 3D printing of polyether-block-amide, polyamides, polyether ether ketone, polyether ketone ketone, and fluoropolymer objects, especially objects of polyvinylidene fluoride (PVDF) and its copolymers. One particularly useful miscible polymer is an acrylic polymer, which is miscible with the fluoropolymer in the melt. The support structure composition provides the needed adhesion to the build plate and to the printed object and support strength during the 3D printing process, yet it is removable after the fluoropolymer object has cooled. The support polymer composition is selected to be stiff and low warping, yet flexible enough to be formed into filaments.

### BACKGROUND OF THE INVENTION

3D printing is an additive manufacturing process, involving the printing or manufacturing of an object through a process of adding material layer by layer. Each layer is added on top of an earlier printed layer. The printing process is relatively straightforward, when a simple object with straight and vertical walls, is printed. However, most objects are not so simple in structure and include curved surfaces and surfaces that could overhang outside the main body of the object. The surfaces could be inclined, oriented at different angles and have different thicknesses or sizes.

Printing or manufacturing of such protruding or overhanging surfaces during material extrusion additive manufacturing is usually accomplished by introducing support structures similar to scaffolds used in building construction. In addition, a sacrificial substrate printed with the secondary material is often laid down before printing with the main material, often called a raft. This support base provides further adhesion to the build plate and resistance against warping and build plate delamination. The supports are removed after completion of the printing process.

In determining the scaffolding material or support structure to be used in printing, several key elements are desired, including a) the printability of the support material, b) high adhesion of the support material to the build plate, c) low warpage tendency, d) the ability of the support material and the build material to adhere to each other in the melt during the printing process. Other desirable elements include: e) having the support material and build material of similar viscosities at the print temperature, f) a high melt strength support is needed—in order to support the build material, g) a high modulus support is preferred when supporting a build material that has a tendency to shrink or warp.

Often, the support structures are made of the same material of which the 3D object is made. Small gaps between the support material and build material can be programed into the architecture to allow the support to be easily detached from the build material 3D object, following the 3D manufacturing process.

It is also possible to use different materials for the support and build materials, for example in U.S. Pat. No. 8,974,213.

Water-soluble or solvent-soluble support structures have been used for printing acrylonitrile butadiene styrene (ABS), polystyrene (PS), polypropylene (PP), polyethylene (PE) and nylon.—such as found in US 2019/0202134.

US 2019/0001569 describes the use of a cyclic olefin copolymer (COC) and cyclic olefin polymer (COP) as a support material for 3D printing of high temperature polymers, such as polyimides. The COC and COP polymer supports have a sufficient melt strength to support the build material, but also breaks away at room temperature because of a lack of adhesion and/or a difference in thermal expansion between the support material and build material. A key property of the polymer support is an appropriate viscosity vs. shear rate at the process temperature.

Until now, there has been no support material developed to support fluoropolymers, and specifically 3D printable polyvinylidene fluoride (PVDF) as described in US 2019/0127500. Common soluble support materials, such as polyvinyl alcohol (PVA) are too soft, cannot counter the warpage of PVDF, and do not adhere well to PVDF. On the other hand, for stiff materials like ABS and other plastic breakaways, PVDF does not adhere well to them and they do not adhere well to PVDF. PMMA is described as being alloyed with PVDF at a low PMMA level, but is not described as a separate support mechanism alone.

WO 2017/210285 (U.S. Ser. No. 16/305,123), to Arkema, describe a dimensionally stable acrylic polymer composition useful in 3D printing.

WO 2019/067857, to Arkema, mentions that a polymethyl methacrylate (PMMA) film may be used to improve the base adhesion for PVDF printing. The PMMA is not used as a printable filament, and no specific type of acrylic copolymer or alloy are described.

### Problem

The problem solved by the invention is to develop a useful support material for the 3D printing of a fluoropolymer and other polymers, and PVDF polymer composition in particular. The support material must be able to be removed from the 3D printed object after the object is formed. The support material must be easily printable (easy to 3D print and stick to the build plate), must be stiff enough to serve as a support, must resist the warpage and shrinkage exhibited by the cooling of the (semicrystaline) build material, and must be compatible in the melt with the polymer (particularly fluoropolymer) build material.

Certain polymers, including polyether-block-amide, polyamides, polyether ether ketone, polyether ketone ketone, fluoropolymers, and PVDF polymers specifically, are desired in 3D printed parts due to their extremely high chemical resistance, durability, flame resistance, and mechanical properties. However, these polymers, and particularly PVDF are very difficult to 3D print because they have poor adhesion to glass and other materials while having a high percentage of crystallinity, and thus a high percentage of shrinkage leading to warping.

New, more printable PVDF compositions have been developed by Arkema (US 2019/0127500), and include the blending of fluoro-copolymers with fluoro-homopolymers, and blends with compatible or miscible polymers. The copolymers or blends are softer and have better adhesion to glass and thus warp off the bed less, but due to their elastomeric properties and viscosity properties, tend to shrink a lot, have poor overhang resolution, and still don't adhere to glass as well as other elastomeric materials.

### Solution

It has now surprisingly been found that specially selected compatible or miscible polymer compositions can be used as support materials for the 3D printing of polyether-block-amide, polyamides, polyether ether ketone, polyether ketone ketone, and fluoropolymers. Acrylic compositions containing polymethyl methacrylate, its copolymers, blends, and alloys can be used as an effective support for these 3D printed polymers, and in particular PVDF. The specially formulated, printable acrylic composition allows for the printing of significantly larger, more complicated parts than could previously be printed. In addition, as a support, the support structures of the invention allow one to print parts and features that have previously not been able to be printed, including parts that have overhangs, increasing the design freedom a person has with 3D printing of fluoropolymers, and parts that have been only made by traditional processes, such as injection molding. Some of the printed parts of the invention could not even be made by an injection molding process.

The acrylic support composition provides excellent printing, high build plate adhesion, high stiffness (modulus) and low warping. Impact modifiers allow for some reduction in modulus, but the resulting compositions are still stiff enough to fight against PVDF's warpage.

Compared with ABS, and PETG which have a lower modulus and no compatibility with PVDF, the acrylic support composition of the invention is stiff enough to fight against PVDF's warpage and compatible enough to adhere to the surface of PVDF and for PVDF to adhere to the surface of the acrylic support during printing.

Importantly, the acrylic support composition of the invention can be easily removed following the 3D printing of a fluoropolymer object, either by a physical removal, or preferably by dissolution.

### SUMMARY OF THE INVENTION

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Aspects of the invention include:

In a first aspect, a support material composition for 3D printing of polyamide (PA), polyether-block polyamides (PEBA), polyether ketone ketone (PEKK), and fluoropolymer compositions, wherein said support material composition comprises one or more polymer compositions compatible, miscible or semi-miscible with said PA, PEBA, PEEK, PEKK or fluoropolymer composition.

In a second aspect, the support material composition comprises an acrylic, polyester of polycabonate composition, preferably acrylic, and most preferably a PMMA polymer or copolymer having greater than 51 percent methyl methacrylate monomer units.

In a third aspect, the acrylic support material is chosen from acrylic copolymers, acrylic alloys, and acrylic polymers blended with non-polymeric additives.

In a fourth aspect, the acrylic composition of the above aspects has a Tg of less than 165° C., less than 135° C., less than 125° C., preferably less than 115° C., less than 110° C., preferably less than 95° C., preferably less than 90° C., and preferably less than 80° C. Preferably, the Tg is above room temperature, preferably above 30° C., more preferably above 40° C., more preferably above 50° C., and even above 60° C.

In a fifth aspect, the acrylic composition of the above aspects has a low shear rate viscosity as measured at 4 sec⁻¹ of less than 100,000 Pa-s by capillary rheometry according to ASTM C965, and preferably of less than 10,000 Pa-s, and more preferably less than 5,000 Pa-s at a temperature of 230° C., and preferably a low shear rate viscosity of greater than 50 Pa-s, and more preferably greater than 100 Pa-s.

In a sixth aspect, the support material composition of the above aspects, contains at least 20 wt %, preferably at least 30 wt %, more preferably at least 40 wt %, more preferably at least 51 wt %, more preferably at least 60 wt %, more preferably at least 70 wt % of one or more acrylic polymers, where the acrylic polymer comprises polymethyl methacrylate homopolymer, or copolymer containing at least 51 wt %, greater than 70 wt %, and preferably greater than 75 wt % methyl methacrylate monomer units.

In a seventh aspect, the support material composition of the above comprises as the acrylic polymer matrix a copolymer having from 70 to 80 weight percent of methyl methacrylate monomer units, and from 20 to 30 weight percent of C₁₋₄ acrylate units. The support material composition alternatively may be a blend of a methacrylate copolymer and polylactic acid polymer and other acrylic polymers.

In the eighth aspect, the support material of the above aspects contains an acrylic composition that is impact modified, having from 5-60 weight percent of impact modifiers.

In a ninth aspect, the support material composition of the above aspects, further comprises additives selected from the group consisting of optical brighteners, impact modifiers, process aids, rheology modifiers, thermal and UV stabilizers, fluorescent and non-fluorescent dyes and pigments, radio-opaque tracers, fillers, conductive additives, solubility enhancers, mechanical removal enhancers, lubricants, plasticizers, and mixtures thereof.

In a tenth aspect, the support material composition of any of the previous aspects, is soluble in a solvent selected from the group consisting of water, hot water, aqueous alkaline solution, and ethanol.

In an eleventh aspect, the support material composition of the above aspects comprises said fillers that are polymers, salts and other compounds that are soluble in a mild solvent such as cold water, hot water, aqueous alkaline or acid solutions, ethanol, or a harsher solvent such as acetone, tetrahydrofuran, toluene, dichloromethane, chloroform, xylene and toluene.

In a twelfth aspect, the fluoropolymer supported be the support material of the previous aspects has a low shear rate viscosity at 232° C. and 4 sec⁻¹ of less than 13,000 Pa-s, as measured by capillary rheomometry, and a high shear rate viscosity of 30 to 2000 Pa-s at 232° C. and 100 sec⁻¹, as measured by capillary rheomometry at the temperature given in the ASTM Melt Flow Testing for that fluoropolymer.

In a thirteenth aspect, the an acrylic support composition for 3D printing of an object is presented, where the object composition comprises one or more polymers compatible, miscible or semi-miscible said acrylic-compatible composition.

In a fifteenth aspect, the acrylic compatible polymer is a polyvinylidene fluoropolymer or copolymer, and may be an alloy blend with an acrylic polymer or copolymer, or a PVDF copolymer, such as PVDF/HFP.

In a sixteenth aspect, a process for printing a 3D object is presented, using a support material composition and a build material, comprising the step of printing both the 3D build material and support material, wherein said support material is compatible, miscible or semi-miscible with a fluoropolymer build material, and the step of removing the support material composition after formation of the 3D printed object.

In a seventeenth aspect, the process of aspect sixteen involves the removal of the support material due to a physical breaking or dissolution of the support material, the dissolution involving solubility in xylene, toluene, acetone, tetrahydrofuran, toluene, dichloromethane, chloroform cold water, hot water, ethanol, aqueous alkaline solution, and aqueous acid solution, mixtures thereof, and other known solvents for the support material.

### BRIEF DESCRIPTION OF THE DRAWINGS

FIG. 1: Shows the specimen used to quantify the warping of different polymers. It has a small surface area in contact with the build plate as well as well as sharp corners, which tend to exacerbate warping

FIG. 2: Shows the cross sectional area of the warping test specimen used in the warping test. The specimen increases in the vertical, Z, direction, so the part is more challenging to print as the print continues.

FIG. 3: Shows the specimen of Example 2 that has been made 50% shorter to decrease print time and increase the stability of the part during printing. Two Specimens are printed simultaneously and connected to create a specimen that will not topple over during printing. The material type switches within the gauge to create section order to test the bond strength of the material interfaces. The specimen features both PVDF to support interfaces and support to PVDF interfaces.

FIG. 4: The object printed, in Example 4 with the support structure intact.

FIG. 5: An example part which feature a pipe fitting printed with Arkema Kynar® 826-3D resin and the PLEXIGLAS® 3DS support material

### DETAILED DESCRIPTION OF THE INVENTION

As used herein copolymer refers to any polymer having two or more different monomer units, and would include terpolymers and those having more than three different monomer units. The copolymers may be random or block, may be heterogeneous or homogeneous, and may be synthesized by a batch, semi-batch or continuous process.

Molecular weights are given as weight average molecular weights, as measured by GPC. Percentages are given as weight percents, unless otherwise noted. The references cited in this application are incorporated herein by reference.

“Build material”, as used herein, means the material used to form the final 3D object or article.

“Support material”, as used herein, means the material forming the scaffolding, which supports the build material, and in particular the build material overhangs, and which is removed once the final article has been 3D printed. The supported overhangs could be external on the printed object, or could be internal for a hollow object. The support material may also be used as the base or raft, on which the build material, and/or the support material is printed. The support material may also be used to print a marking or identifying label on the build material which may or may not be removed.

“Low shear viscosity”, as used herein is a measure of the melt viscosity (ASTM D3835-0) at a relatively low shear rate. This relates to the viscosity of the melt following printing. For purposes of this invention, the low shear rate at which viscosity is measured is at 4 sec⁻¹ as measured by capillary rheometry. The actual shear rate of the polymer alloy following printing is essentially zero.

“High shear viscosity” as used herein is a measure of the melt viscosity at a relatively high shear rate. This relates to the viscosity of the melt as it moves through the nozzle on a 3-D printer. The high shear rate viscosity is measured herein as the melt viscosity at a shear of 100 sec⁻¹ as measured by capillary rheometry. The viscosity of the melt under high shear is generally lower than the viscosity of the polymer melt under low shear, due to shear thinning.

“Compatible polymers”, as used herein refers to polymers that are immiscible with each other, but as a blend exhibit macroscopically uniform physical properties. The macroscopically uniform properties are generally caused by sufficiently strong interactions between the component polymers.

“Miscible polymers”, as used herein refers to two or more polymers that form a homogeneous polymer blend that is a single-phase structure, having a single glass transition temperature.

“Soluble” as used herein to describe the support polymer composition that can be removal by dissolution, means that at least 10% of the support polymer composition dissolves and is removed in an hour of exposure to the appropriate solvent, or in the case of a swellable polymer, the mass increase of the polymer after 4 hours of exposure to the appropriate solvent, is at least 10 percent.

### Compatible Polymer Support

The invention makes use of special, compatible, miscible or semi-miscible polymer compositions as the support materials for the 3D printing of fluoropolymers, and other polymers, such as polyether-block-amide, polyamides, polyether ether ketone, polyether ketone ketone. The key properties for a good support are miscibility/compatibility with the build polymer, a printable viscosity at the print temperature, a high stiffness in order to provide support, low warping, enough flexibility enabling the support material to be formed into a filament and rolled onto a spool, good adhesion to the build plate during printing, and good adhesion to the build material to provide enough support. The compatible, miscible or semi-miscible polymer is used as the matrix of the support composition.

Some useful compatible, miscible or semi-miscible polymers useful as the support matrix polymer include, but are not limited to, acrylics, PLA, and copolyesters, and blends thereof. Polycarbonates could be useful where a low-warping version is used.

In one embodiment, the compatible, miscible or semi-miscible polymer support composition is specially formulated for good printability.

In one embodiment, good printability is obtained through the use of a low Tg composition. The Tg is relative to the print conditions, which printability is possible with a support composition Tg well below the print parameters. In the case of a build plate, the build plate is preferably heated to or above the Tg of the support to improve the build plate adhesion of a support material or raft. The lower Tg of the acrylic composition can be achieved by several different means, including the formation of alloy compositions having one or more acrylic polymers with one or more low viscosity polymers, a low Tg acrylic copolymer, one or more acrylic polymers blended with one or more non-polymeric additives, or a combination of these techniques.

The advantages of the low Tg composition are several: a) the acrylic composition can be formed by a material extrusion additive manufacturing process (also referred to in this application as 3-D printing) at relatively low temperatures; b) the acrylic composition is flexible enough to be formed into a filament, and be spooled; c) the acrylic composition needs to be able to stick well to glass and not warp, and d) the lower Tg and low viscosity acrylic composition provides the proper fluidity at print conditions for good 3D printing. Further, there does not appear to be a negative impact of the low Tg acrylic composition when used with PVDF, even though PVDF has a Tc greater than acrylic copolymer's Tg.

The acrylic composition useful in the invention has an over-all Tg of less than 165° C., less than 135° C., less than 125° C., less than 105° C., less than 95° C., less than 85° C., and preferably less than 80° C. The low Tg acrylic can be obtained in several ways. These include, but are not limited to a) an acrylic homopolymer or copolymer having the requisite Tg, b) a blend of an acrylic polymer and at least one a low melt viscosity polymer—which may be an acrylic copolymer, and c) a blend of a higher Tg acrylic polymer with a non-polymeric component which reduces the over-all composition Tg, such as a plasticizer, and a combination of the above.

Tg is used as a surrogate measure of the transition temperature, the temperature where the material goes from being liquid-like to solid-like as seen by rheology. By the transition, temperature is meant the point where the log of viscosity vs. temperature changes slope following the Arrhenius equation from liquid-like to solid-like behavior. This transition point can be obtained by measuring the viscosity vs. temperature of the material at low shear going from melt phase to room temperature. A transition temperature that is less than 10° C. above the build plate temperature during printing (typically heated to 80° C. to 120° C.) is desired, preferably 10° C. lower, 20° C. lower, even more 25° C. lower, and 30 C lower. The Tg of an acrylic is roughly 25° C. lower than the transition temperature. In other words, a Tg of below 100° C., 85° C., 80° C., 75° C. and above 60° C. is preferred for a material printed at room temp on a heated bed of 125° C. If a heated chamber is used, the part will experience a higher internal temperature and thus a higher Tg material, such as 135° C. or less, can also be used. The glass transition temperature of a polymer, is measured by DSC according to the standard ASTM E1356. By adjusting different parameters of the process and support materials, it could be possible to successfully print an acrylic composition, as the support material at Tgs up to 135° C. and below.

The acrylic polymer useful in the invention is meant to include polymers, copolymers, and terpolymers formed from alkyl methacrylate and alkyl acrylate monomers, and mixtures thereof. The alkyl methacrylate monomer is preferably methyl methacrylate, which may make up from 50 to 100 percent of the monomer mixture. 0 to 50 percent of other acrylate and methacrylate monomers or other ethylenically unsaturated monomers, included but not limited to, styrene, alpha methyl styrene, acrylonitrile, and crosslinkers at low levels may also be present in the monomer mixture. Other methacrylate and acrylate monomers useful in the monomer mixture include, but are not limited to, methyl acrylate, ethyl acrylate and ethyl methacrylate, butyl acrylate and butyl methacrylate, iso-octyl methacrylate and acrylate, lauryl acrylate and lauryl methacrylate, stearyl acrylate and stearyl methacrylate, isobornyl acrylate and methacrylate, methoxy ethyl acrylate and methacrylate, 2-ethoxy ethyl acrylate and methacrylate, dimethylamino ethyl acrylate and methacrylate monomers. Alkyl (meth) acrylic acids such as methacrylic acid and acrylic acid can be useful for the monomer mixture. Most preferably the acrylic polymer is a copolymer having 70-99.5 weight percent of methyl methacrylate units and from 0.5 to 30 weight percent of one or more C₁₋₈ straight or branched alkyl acrylate units.

The acrylic polymer has a weight average molecular weight of from 50,000 g/mol to 500,000 g/mol, and preferably from 55,000 g/mol to 300,000 g/mol and preferably from 5,000 to 200,000 g/mol. It has been found that the use of acrylics having a lower weight average molecular weight in the range, improves the printability of the material as seen by higher fluidity of the material during print, quicker printing speeds, increases the transparency and reduces warpage.

Preferably, the acrylic polymer contains little or no very high molecular weight fraction polymer, with less than 5 weight percent of the acrylic polymer, and preferably less than 2 weight percent of the acrylic polymer having a molecular weight of greater than 500,000 g/mol.

In another embodiment, the acrylic polymer composition comprises a blend of two or more of the polymers described above.

The acrylic polymer may be formed by any known means, including but not limited to bulk polymerization, emulsion polymerization, solution polymerization and suspension

### Acrylic Copolymers:

The acrylic copolymers of the invention, have a Tg generally below 165° C., below 135° C., below 125° C., below 105° C., preferably below 95° C., preferably below 85° C., preferably below 80° C. and more preferably below 75° C. The acrylic copolymer of the invention has a Tg above 50° C., preferably above 55° C., and more preferably above 60° C.

In one preferred embodiment, at least 40 weight percent, preferably at least 50 weight percent, and most preferably at least 60 weight percent of the monomer units in the acrylic copolymer are methylmethacrylate monomer units. The co-monomers selected for the acrylic copolymer could be (meth)acrylic monomers, non-(meth)acrylic monomers, or mixtures thereof.

In one preferred embodiment, the acrylic copolymer is composed of greater than 90 weight percent, greater than 95 weight percent, and most preferably 100 weight percent acrylic monomers units. Low Tg acrylic monomers that can be copolymerized to lower the copolymer Tg to the specified level include, but are not limited to methyl acrylate, ethyl acrylate, butyl acrylate, ethylhexyl acrylate, hydroxyl ethyl acrylate, hydroxyl propyl acrylate, hydroxyl butyl acrylate, hexyl methacrylate, lauryl methacrylate, and butyl methacrylate. These monomers are added at levels high enough to lower the Tg below 85° C., preferably below 80° C. and more preferably below 75° C., the Tg being easily calculated using the Fox equation, as is well known in the art and can be measured by DSC.

The lower Tg copolymers tend to have a lower viscosity than higher Tg polymers, though other factors like molecular weight and branching will also effect viscosity. Impact modifiers, can be, and are preferably added to the composition to both improve the impact strength and also increase the melt flow viscosity.

### Acrylic Alloys

An alternative means for providing an overall lower Tg acrylic composition involves alloy blends of one or more higher Tg acrylic polymer(s) with one or more lower Tg (lower melt flow) polymers. This method is described in WO 2017/210,286.

The low melt viscosity polymer in the acrylic alloy composition must be compatible, semi-miscible, or miscible with the acrylic polymer. The low melt viscosity polymer and acrylic polymer should be capable of being blended in a ratio such that a single intimate mixture is generated without separation into distinct bulk phases. By “low melt viscosity polymer”, as used herein means polymers having a melt flow rate of greater than 10 g/10 minutes, and preferably greater than 25 g/10 minutes as measured by ASTM D1238 at 230° C./10.4 kg of force.

In one embodiment, the low melt viscosity polymer is a low molecular weight acrylic polymer or copolymer, meeting the high melt flow rate criteria. The low molecular weight acrylic polymer has a weight average molecular weight of less than 70,000, preferably less than 50,000, more preferably less than 45,000, and even less than 30,000 g/mol. Acrylic copolymers are preferred, and copolymers with a Tg of less than 100° C., and less than 90° C. are preferred for increased flexibility.

In a preferred embodiment, the low melt viscosity polymer of the invention is a polymer other than an acrylic polymer. The non-acrylic low melt viscosity polymer of this invention includes, but is not limited to, polyesters, cellulosic esters, polyethylene oxide, polypropylene glycol, polyethylene glycol, polypropylene glycol, styrene-acrylonitrile copolymers, polyvinyl chloride, polyvinyl acetate, polyvinyl alcohol, ethylene-vinyl acetate copolymers, polyvinylidene fluoride and its copolymers, olefin-acrylate copolymers, olefin-acrylate-maleic anhydride copolymers, and maleic anhydride-styrene-vinyl acetate copolymers, and mixtures thereof.

Useful polyesters include, but are not limited to: poly(butylene terephthalate), poly(ethylene terephthalate), polyethylene terephthalate glycol, polylactic acid. A preferred polyester is polylactic acid. A useful alloy blend of polylactic acid with acrylic copolymer is the PLEXIGLAS® RNEW® resin blends from Arkema. In another embodiment, PLA and acrylic copolymer blends, having acrylic co-monomers of C₁₋₆ acrylates, and/or acid monomers such as (meth)acrylic acid, could be used, and would have improved water solubility to provide easier removal of the support.

Useful cellulosic esters include, but are not limited to: cellulose acetate, cellulose triacetate, cellulose propionate, cellulose acetate propionate, cellulose acetate butyrate, and cellulose acetate phthalate.

The acrylic alloy composition of the invention can be defined by its low shear and high shear viscosity. Preferably, the acrylic alloy composition of the invention has a low shear rate viscosity as measured at 1 sec⁻¹ of less than 100,000 Pa-s. by a rotational viscometry according to ASTM C965, and preferably of less than 10,000 Pa-s, preferably less than 4,000 Pa-s, and more preferably less than 1,000 Pa-s at a temperature of 230° C. Preferably the low shear viscosity is greater than 50 Pa-s, and more preferably greater than 100 Pa-s. If the low shear viscosity is less than this, it is likely not to have a sufficient melt strength for the production of filament. While not being bound by any particular theory, this low-shear viscosity range seems to allow the printed polymer to stay where it is placed, and yet still be fluid enough for good interlayer adhesion and fusion. The low and high shear viscosity ranges are for the alloy composition before the addition of additives. Some additives could push the viscosity much higher.

Preferably the acrylic alloy composition has a high shear viscosity of from 20 to 2,000 Pa-s, preferably 25 to 1,000 Pa-s, preferably 30 Pa-s to 500 Pa-s, at the temperature of deposition and 100 sec⁻¹. The key viscosity behavior is a combination of both the viscosity of the material coming out of the nozzle, and how fluid the material stays as the thermoplastic solidifies. A typical nozzle temperature for use in determining the high and low shear viscosity is 230° C.

In one embodiment, the low melt viscosity polymer has a weight average molecular weight higher than the entanglement molecular weight of that polymer, as measured by gel permeation chromatography.

The low melt viscosity polymer makes up from 5 to 60 weight percent of the total alloy composition, preferably from 9 to 40 weight percent.

In one embodiment, the support material composition may include blends with less miscible or compatible materials to provide high enough adhesion and to the build material during printing, but also low enough adhesion to improve mechanical or solvent removal following the print.

In one embodiment, the support material is formulated for improved removal of the support material after printing. For example, the highly printable acrylic copolymer may be blended with one or more components, that increase the ability to remove the support composition. The added materials could be for example alkaline soluble acrylics or non-acrylic polymers such as polyvinyl alcohol (PVA) or polylactic acid (PLA). Those materials are not necessarily compatible with PVDF, but when blended with acrylic copolymer of the invention the composition as a whole is compatible. Examples of such blends include PMMA+PLA vs. PLA alone.

There are some non-MMA acrylic-based support materials in the art, including some alkaline soluble acrylic resins used in 3D printing as soluble supports. They are not MMA based and alone are not compatible with PVDF. However, when blended with the acrylic composition of the invention, the blend would be compatible with PVDF. Such a blend would need a minimum of 20% MMA containing acrylic copolymer, preferably more than 30%, more than 40%, more than 50%, more than 60%, more than 70%, preferably more than 80%, and even more than 90% of PMMA polymer or acrylic copolymer.

Acrylic Blends with Non-Polymers

A third method for providing an over-all acrylic composition having a low Tg is to blend a higher Tg acrylic polymer with one or more compounds known to lower the Tg, such as, but not limited to, plasticizers and fillers. However, lowering the Tg is not necessarily enough to provide good printability which is the key criteria, combined with low warpage. Lower Tg, by itself could result in a material too soft for good printability, and may have too high warpage. The balance, provided by this invention, is desired.

The additive compound must be compatible, miscible or semi-miscible with the acrylic polymers that will for the matrix. The Tg-lowering additive is typically added at from 2 to 40 weight percent, based on the weight of the acrylic polymer, preferably from 4 to 20 weight percent

In one embodiment, a useful class of plasticizers are specialty epoxides, such as 1,2 dihydroxy alkanes with a molecular weight above 200 grams per mole or vegetable oil polyols having a molecular weight above 200 grams per mole, as described in PCT/US2019/012241.

In another embodiment, phthalates, such as di (2-ethyl hexyl) phthalate, diisononyl phthalate, diisodecyl phthalate, and diisooctyl phthalate, could be used

In another embodiment, adipates, such as, but not limited to di(2-ethyl hexyl) adipate, could be used.

In another embodiment, water- or alcohol-soluble materials are added. These fillers could decrease the effective Tg, but would primarily serve to make the acrylic support composition easily removable following the 3D print of the fluoropolymer article.

### Impact Modifiers

While the acrylic compositions of the invention may contain no impact modifier, in a preferred embodiment, and to avoid being too fragile, the acrylic composition of the invention includes one or more types of impact modifiers. Preferably the acrylic composition contains impact modifiers at a level of from 5 to 60 weight percent, preferably 9 to 50 weight percent, and more preferably from 20 to 45 weight percent, based on the overall composition. The impact modifiers can be any impact modifier that is compatible, miscible, or semi-miscible with the acrylic composition, as known in the art. Useful impact modifiers include, but are not limited to linear block copolymers and both soft-core and hard-core core-shell impact modifiers. In a preferred embodiment, the impact modifiers have MMA-rich acrylic blocks, or acrylic shells—improving the compatibility with a fluoropolymer.

While not being bound by any particular theory, it is believed that the impact modifier provides elongation, flexibility, and toughness.

In a preferred embodiment, the impact modifier of the invention is a multi-stage, sequentially-produced polymer having a core/shell particle structure of at least three layers made of a hard core layer, one or more intermediate elastomeric layers, and a hard shell layer. The presence of a hard core layer provides a desirable balance of good impact strength, high modulus, and excellent UV resistance, not achieved with a core/shell modifier that possesses a soft-core layer.

Preferably the multi-stage polymer is a three stage composition wherein the stages are present in ranges of 10 to 40 percent by weight, preferably 10 to 20 percent, of the first stage (a), 40 to 70 percent, preferably 50 to 60, of the second intermediate stage (b), and 10 to 50 percent, preferably 20 to 40, of the final stage (c), all percentages based on the total weight of the three-stage polymer particle.

In one embodiment the core layer is a crosslinked polymethylmethacrylate-ethylacrylate copolymer, the middle layer is a crosslinked polybutylacrylate-styrene copolymer, and the outer shell is a polymethylmethacrylate-ethylacrylate copolymer.

The multi-stage polymer can be produced by any known technique for preparing multiple-stage, sequentially-produced polymers, for example, by emulsion polymerizing a subsequent stage mixture of monomers in the presence of a previously formed polymeric product. In this specification, the term “sequentially emulsion polymerized” or “sequentially emulsion produced” refers to polymers which are prepared in aqueous dispersion or emulsion and in which successive monomer charges are polymerized onto or in the presence of a preformed latex prepared by the polymerization of a prior monomer charge and stage. In this type of polymerization, the succeeding stage is attached to and intimately associated with the preceding stage.

An alternative impact modifier useful in the invention is a block copolymer, such as NANOSTRENGTH® resin from Arkema. Lesser amounts, for example 10-15% of the NANOSTRENGTH block copolymer, could work to provide effective impact strength.

In one preferred embodiment, the acrylic copolymer contains 70-80 weight percent of methylmethacrylate monomer units, and 20-30 weight percent of methyl acrylate, ethyl acrylate units, or a mixture thereof.

In a preferred embodiment MMA containing impact modifier (core-shell or Nanostrength®) are used both for flexibility, and for PVDF compatibility. Adding some MMA containing impact modifier would help an otherwise low compatible soluble acrylic have increased compatibility and adhesion to PVDF. Preferably the impact modifier itself comprises greater than 10 wt %, greater than 20 wt %, greater than 30 wt %, greater than 40 wt %, and even greater than 50% of MMA monomer units.

### Additives

The acrylic composition may further contain other additives typically present in acrylic formulations, including but not limited to, stabilizers, plasticizers, fillers, coloring agents, pigments, antioxidants, antistatic agents, surfactants, toner, refractive index matching additives, additives with specific light diffraction or light reflection characteristics, lubricants, solubility enhancers, mechanical removal enhancers, and dispersing aids. If fillers are added, they represent 0.01 to 50 volume percent, preferably 0.01 to 40 volume percent, and most preferably from 0.05 to 25 volume percent of the total volume of the acrylic alloy composition.

The fillers can be in the form of powders, platelets, beads, fibers and particles. Smaller materials, with low aspect ratios are preferred, to avoid possible fouling of the nozzle, though this is less important when the acrylic alloy is used with larger nozzle sizes. Useful fillers include, but are not limited to, carbon fiber, carbon powder, milled carbon fiber, carbon nanotubes, glass beads, glass fibers, nano-silica, Aramid fiber, polyarylether ketone fibers, BaSO₄, talc, CaCO₄, graphene, nano-fibers (generally having an average fiber length of from 100 to 150 nm) and hollow glass or ceramic spheres. Polar, hydrophilic or water soluble fillers, such as NaCl or other salts can be added to improve the ease of support removal following printing. In addition, inert fillers such as talc, CaCO₄, glass beads, and other minerals and salts, which the model material does not adhere to well, can be added to improve the ease of physical removal of the support from the model material.

The acrylic composition of the invention is compatible with the model material, prints with little warpage, is stiff with a tensile mod preferably greater than 1.5 GPa, >1.7 GPa, >1.9 GPa, >2 GPa, and yet is flexible enough to be fillamented. When used with the acrylic composition of the invention as support and raft, a much larger, less warping, PVDF part can be printed and certain part features (like overhangs) that could not otherwise be printed, can now be printed.

Modifications to the acrylic polymer can be made, based on the information in this application to one of ordinary skill in the art, to make the acrylic polymer more soluble in water or ethanol or other common solvents, yet providing at the same time compatability with PVDF. This could help in removing the support acrylic material from the final object, once formed. In one embodiment, NANOSTRENGTH® acrylic block copolymers from Arkema are more hydrophilic, and could be removed easily following printing. In the case where a fully modified alkaline, or water, or ethanol, or other common solvent soluble acrylic becomes less or no longer compatible with the fluoropolymer build material and thus not usable as a compatible support, one can blend that more soluble support with more compatible acrylics such as MMA-containing acrylic (co)polymer to improve it's compatibility with the fluoropolymer build material.

Fluoropolymer and other Build Polymers

The build polymer could be a fluoropolymer, or may also be others polymers such as polyether-block-amide, polyamides, polyether ether ketone, polyether ketone ketone, The invention will be illustrated using fluoropolymers, and specifically polyvinylidene fluoride. However, one of ordinary skill in the art will recognize that other similar polymers to PVDF can be substituted as the build material over the inventive support material.

The acrylic support composition of the invention is used to support a fluoropolymer build material. The big advantage of the acrylic compositions in supporting fluoropolymers, is that the acrylics are melt-miscible with fluoropolymers, and thus allow for needed adhesion between the support and build materials. While the invention contemplates an acrylic support for a fluoropolymer, one of skill in the art will recognize from the description herein that the acrylic support may be used in conjunction with other 3D printed objects having a composition compatible, miscible or semi-miscible with the acrylic support.

Useful fluoropolymers for 3D printing are those having a low shear melt viscosity, to provide printability, and a minimized warping on cooling. Examples of such fluoropolymers are provided in US 2019/0127500 to Arkema. The useful fluoropolymer compositions include fluoropolymer blends, and the use of specific fillers. The process conditions can be adjusted, to further reduce the negative effects of the fluoropolymer crystallinity on the print properties.

Fluoropolymers useful in the invention include homopolymers or copolymers containing fluorinated monomers. The presence of fluorine on the polymer is known to impart enhanced chemical resistance, reduced coefficient of friction, high thermal stability, and enhancement of the material's triboelectricity. The term “fluoromonomer” or the expression “fluorinated monomer” means a polymerizable alkene which contains in its structure at least one fluorine atom, fluoroalkyl group, or fluoroalkoxy group whereby those groups are attached to the double bond of the alkene which undergoes polymerization. The term “fluoropolymer” means a polymer formed by the polymerization of at least one fluoromonomer, and it is inclusive of homopolymers and copolymers, and both thermoplastic and thermoset polymers. Thermoplastic polymers are capable of being formed into useful pieces by the application of heat and pressure, such as is done in 3-D printing. While thermoset fluoropolymers generally are not processed by 3-D printing, the precursors to, and oligomers of, the thermoset polymer could be printed, assuming the viscosity is adjusted to allow for a viscosity capable of being 3-D printed. Thickeners could be used to increase the viscosity of the pre-polymers, if needed, as known in the art. Conversely, plasticizers or diluents could be added to decrease the viscosity of the pre-polymers. Once the pre-polymers are 3-D printed together, they can then be cured (functionality reacted and cross-linked) using an appropriate energy source, such as heat, UV radiation, e-beam, or gamma radiation. One non-limiting example of a thermoset fluoropolymer would be the use of vinylidene fluoride and hexafluoropropene monomers with a fluoromonomer having bromide functionality. The brominated fluoropolymer could be 3-D printed, followed by radical cross-linking through the bromine functionality using a pre-added thermal radical source, or one that generates radicals upon application of light, UV, electron-beam, or gamma radiation.

The fluoropolymers may be synthesized by known means, including but not limited to bulk, solution, suspension, emulsion, and inverse emulsion processes. Free-radical polymerization, as known in the art, is generally used for the polymerization of fluoromonomers.

Fluoromonomers useful in the practice of the invention include, for example, vinylidene fluoride (VDF), tetrafluoroethylene (TFE), trifluoroethylene (TrFE), chlorotrifluoroethylene (CITE), dichlorodifluoroethylene, hexafluoropropene (HFP), vinyl fluoride (VF), hexafluoroisobutylene (FEW), perfluorobutylethylene (PFBE), 1,2,3,3,3-pentafluoropropene, 3,3,3-trifluoro-1-propene, 2-trifluoromethyl-3,3,3-trifluoropropene, 2,3,3,3-tetrafluoropropene, 1-chloro-3,3,3-trifluoropropene, fluorinated vinyl ethers including perfluoromethyl ether (PMVE), perfluoroethylvinyl ether (PEVE), perfluoropropylvinyl ether (PP VIE), perfluorobutylvinyl ether (PBVE), longer chain perfluorinated vinyl ethers, fluorinated dioxoles, partially- or per-fluorinated alpha olefins of C₄ and higher, partially- or per-fluorinated cyclic alkenes of C₃ and higher, and combinations thereof. Fluoropolymers useful in the practice of the present invention include the products of polymerization of the fluoromonomers listed above, for example, the homopolymer made by polymerizing vinylidene fluoride (VDF) by itself or the copolymer of VDF and RFP.

In one embodiment of the invention, it is preferred that all monomer units be fluoromonomers, however, copolymers of fluoromonomers with non-fluoromonomers are also contemplated by the invention. In the case of a copolymer containing non-fluoromonomers, at least 60 percent by weight of the monomer units are fluoromonomers, preferably at least 70 weight percent, more preferably at least 80 weight percent, and most preferably at least 90 weight percent are fluoromonomers. Useful comonomers include, but are not limited to, ethylene, propylene, styrenics, acrylates, methacrylates, (meth)acrylic acid and salts therefrom, alpha-olefins of C4 to C16, butadiene, isoprene, vinyl esters, vinyl ethers, non-fluorine-containing halogenated ethylenes, vinyl pyridines, and N-vinyl linear and cyclic amides. In one embodiment, the fluoropolymer does not contain ethylene monomer units.

In a preferred embodiment, the fluoropolymer contains a majority by weight of vinylidene fluoride (VDF) monomer units, preferably at least 65 weight percent VDF monomer units, and more preferably at least 75 weight percent of VDF monomer units. Copolymers of VDF, and preferably copolymers of VDT and HFP, are especially preferred. The comonomer reducing the level of crystallinity of the copolymer.

Other useful fluoropolymers include, but are not limited to, polychlorotrifluoroethylene (CITE), fluorinated ethylene vinyl ether (FEVE), and (per)fluorinated ethylene-propylene (FEP).

Fluoropolymers and copolymers may be obtained using known methods of solution, emulsion, and suspension polymerization. In a preferred embodiment, the fluoropolymer is synthesized using emulsion polymerization whereby the emulsifying agent (‘surfactant’) is either perfluorinated, fluorinated, or non-fluorinated. In one embodiment, a fluorocopolymer is formed using a fluorosurfactant-free emulsion process. Examples of non-fluorinated (fluorosurfactant-free) surfactants are described in U.S. Pat. Nos. 8,080,621, 8,124,699, 8,158,734, and 8,338,518 all herein incorporated by reference. In the case of emulsion polymerization utilizing a fluorinated or perfluorinated surfactant, some specific, but not limiting examples are the salts of the acids described in U.S. Pat. No. 2,559,752 of the formula X(CF₂)ₙ—COOM, wherein X is hydrogen or fluorine, M is an alkali metal, ammonium, substituted ammonium (e. g., alkylamine of 1 to 4 carbon atoms), or quaternary ammonium ion, and n is an integer from 6 to 20; sulfuric acid esters of polyfluoroalkanols of the formula X(CF—)₂—CH₂—OSO₃-M, where X and M are as above; and salts of the acids of the formula CF₃—(CF₂)ₙ—(CX₂)ₘ—SO₃M, where X and M are as above, n is an integer from 3 to 7, and m is an integer from 0 to 2, such as in potassium perfluorooctyl sulfonate. The use of a microemulsion of perfluorinated polyether carboxylate in combination with neutral perfluoropolyether in vinylidene fluoride polymerization can be found in EP0816397A1. The surfactant charge is from 0.05% to 2% by weight on the total monomer weight used, and most preferably the surfactant charge is from 0.1% to 0.2% by weight.

The fluoropolymer of the invention can be defined by the low shear and high shear viscosity of the fluoropolymer at the temperature defined for each fluoropolymer by the ASTM Melt flow Rate Testing Method. Preferably, the fluoropolymers of the invention have a low shear rate viscosity as measured at 4 sec⁻¹ of less than 13,000 Pa-s. by capillary rheometry according to ASTM D3835, and more preferably of less than 6,000 Pa-s at the temperature of melt deposition. Preferably the low shear viscosity is greater than 250 Pa-s, more preferably greater than 600 Pa-s, and more preferably greater than 1,000 pa-s. If the low shear viscosity is less than this, it is likely not to have a sufficient melt strength for the production of filament. While not being bound by any particular theory, this low-shear viscosity range seems to allow the printed polymer to stay where it is placed, and yet still be fluid enough for good interlayer adhesion and fusion. Higher low shear viscosity PVDF resulted in a higher level of warpage and shrinkage. Preferably the thermoplastic material has a high shear viscosity of 30 to 2000 Pa-s, preferably 100 to 1700 Pa-s, more preferably 300 Pa-s to 1200 Pa-s, at the temperature of melt deposition and 100 sec⁻¹. The key viscosity behavior is a combination of both the viscosity of the material coming out of the nozzle, and how fluid the material stays at the thermoplastic solidifies and crystallization occurs. In the case of a polyvinylidene fluoride polymer or copolymer, the above melt viscosity ranges are met when measured at 232° C.

Preferably the fluoropolymer or copolymer of the invention is semi-crystalline. While an amorphous polymer could work under the conditions described above, and not being bound to any particular theory, it is believed that some level of crystallinity is useful for 3D printing as it improves interlayer adhesion, and there is a period of time during the crystallization phase change for more chain entanglement between adjacent layers.

In one embodiment, the fluoropolymer of the invention could contain reactive functional groups, either by using a functional monomer, or by a post-treatment. Once the functional polymer is processed into a useful article, it could then be reacted or cross-linked, such as by UV radiation, or e-beam, for increased integrity. Cross-linking is known in the art to generally increase the tensile and flexural moduli, and reduce solubility and permeability of the cross-linked material, all of which could be advantageous physical property enhancements depending on the material's final application.

Blends of two or more different fluoropolymers are contemplated by the invention, as well as blends of two or more fluoropolymers having the same or similar monomer/comonomer composition, but different molecular weights. In one embodiment, softer elastomeric PVDF/hexafluoropropene (HFP) copolymers can be blended with stiffer PVDF homopolymers.

Blends are also contemplated between fluoropolymer and compatible or miscible non-fluoropolymers. In one embodiment, at least 50 weight percent, more preferably at least 60 weight percent, and more preferably at least 70 weight percent of PVDF with a polymethylmethacrylate (PMMA) homopolymer or acrylic copolymer. The acrylic copolymer of the alloy contains at least 50 weight percent, and more preferably at least 75 weight percent of methylmethacrylate monomers units. The melt miscible blend of PVDF with PMMA provides a surprising number of benefits including to reduce and control warpage, improve optical transparency when this is desirable, reduce shrinkage, improve base adhesion, improve layer to layer adhesion, and improve z direction mechanical properties. In addition the overall print quality is surprisingly improved. Low and very low viscosity compatible or miscible non-fluoropolymers can also be used for improved printability.

The compatible non-fluoropolymer could be a block copolymer containing at least one miscible block. The immiscible block could confer other properties like enhanced impact, ductility, optical properties, and adhesive properties. Either block could contain functional groups. In one embodiment, poly(meth)acrylate homo- and co-polymer blocks could be used as the compatible block in the block copolymer.

Blends of the fluoropolymer with other fluoropolymers or non fluoropolymers can be accomplished by any practical means including physical blending of the different polymers as dry ingredients, in latex form, or in the melt. In one embodiment, filaments of two or more polymers are coextruded in a core-sheath, islands in the sea, or other physical structure.

Blends of very low viscosity PVDF, homopolymer or copolymer, of 30 to 1000 Pas at 100 s⁻¹ and 232° C., can be blended with a higher viscosity PVDF to improve interlayer fusion/adhesion. The overall blend will have an average melt viscosity within the range of the invention.

For example, it was found that blending a low viscosity PMMA polymer to a homopolymer PVDF improved its base adhesion, base warpage, shrinkage, and overall printability. Surprisingly, even a small amount ˜5% of PMMA polymer or copolymer added to the PVDF composition yielded a noticeable improvement in base warpage and a 28% reduction in shrinkage and a ˜10% PMMA addition yielded further improvements in base warpage and a 37% reduction in shrinkage.

Similarly, adding a small amount (˜10%) of very low viscosity PVDF copolymer also resulted in improved base adhesion and a 16% reduction in shrinkage even as the part became more elastomeric.

Throughout this application, PVDF and its blends and copolymers will be used as an exemplary fluoropolymer. It is understood that one skilled in the art will understand that other fluoropolymers can be manipulated in a similar manner to provide similar benefits in 3-D printing.

### Fillers

A second means found to provide good fluoropolymer filament for the production of 3-D printed articles involves the use of fillers blended with the fluoropolymer. While not being bound by any particular theory, it is believed that fillers serve to modify the crystallinity of the polymer matrix. Lower crystallinity in the filled fluoropolymer blend composition leads to lower shrinkage. The melt to solid volume change is also reduced by the use of fillers, further reducing shrinkage. In addition, fillers can improve tensile modulus to further reduce warpage and shrinkage.

Fillers can be added to a fluoropolymer by any practical means. Twin-screw melt compounding is one common method whereby fillers can be uniformly distributed into a fluoropolymer and the filled composition pelletized. Fillers could also be dispersed into a fluoropolymer emulsion, with the blend being co-spray-dried, for a more intimate blend of the materials.

In one embodiment, the filler can be compounded into a PVDF-miscible polymer (such as PMMA), and the filled miscible polymer then added to the PVDF.

It was surprisingly found that when a PVDF homopolymer of the low shear melt viscosity described above, was blended with about 20 weight percent of carbon powder, based on the volume of the PVDF/carbon blend, the 3-D printed parts produced had low warpage and shrinkage—and the print quality compares very well with commercially available 3D printing filaments. This filled sample showed better 3D printing quality, including higher definition, than the unfilled homopolymer.

Surprisingly, the mechanical performance of 3D printed parts made with both filled and non-filled fluoropolymer of the invention had enough integrity to produce strong snap fit components, while parts made of commercial polyamide filament cracked when fabricated into similar snap fit articles. For example, for a ball-joint snap fit part printed in the vertical direction, one printed from a commercial polyamide filament broke along the xy direction (z direction failure), whereas the parts printed from carbon filled PVDF homopolymer filament did not. One could expect that a filled material would show a decrease in layer-to-layer adhesion, but no decrease of layer-to-layer adhesion was seen in the carbon powder-filled PVDF.

Fillers can be added to the fluoropolymer at an effective level of from 0.01 to 50 weight percent, preferably 0.1 to 40 and more preferably from 1 to 30 volume percent, based on the total volume of the fluoropolymer and filler. The fillers can be in the form of powders, platelets, beads, and particles. Smaller materials, with low aspect ratios are preferred, to avoid possible fouling of the nozzle. Useful fillers for the invention include, but are not limited to carbon fiber, carbon powder, milled carbon fiber, carbon nanotubes, glass beads, glass fibers, nano-silica, Aramid fiber, PVDF fiber, polyarylether ketone fibers, BaSO₄, talc, CaCO₃, graphene, nano-fibers (generally having an average fiber length of from 100 to 150 nanometers), and hollow glass or ceramic spheres.

One could envision the use of particles with an aspect ratio designed to improve mechanical strength as another alternative to the particulate filler tested so far.

The addition of fillers was found to raise the melt viscosity of PVDF, however, provided that the PVDF composition as a whole was within the specified melt viscosity parameters, the PVDF composition was printable. The addition of filler increased print quality and decreased warpage.

It is expected that the fillers, and especially fibers, can provide excellent shrinkage reduction. One issue with fibers is that they tend to increase the viscosity of the melt, and could clog nozzles. This effect could be minimized by using a lower melt viscosity fluoropolymer, a short aspect ratio fiber, or a larger nozzle size. In addition, filled materials can still warp off the build plate and can use support to decrease it's warping tendencies and to print overhangs and other difficult to print features.

Other common additives may also be added to the fluoropolymer composition in effective amounts, such as, but not limited to adhesion promoters and plasticizers.

The composition of the invention is useful as a removable support for PVDF objects. It is noted that PVDF is a semicrystalline polymer, and is subject to some amount of warpage even when filled. Printing of very large supported parts may be difficult due to the PVDF chemical structure.

While the acrylic support material of the invention is used as a support material for fluoropolymers in a 3D print process, the acrylic support could be useful as a support for other build materials for which it is compatible, semi-miscible, or miscible. Certainly, the acrylic support material could be used to support other acrylic polymer build materials. It could also be used to support polyamides, polyether-block-amides, polylactic acid, polyether ketone ketone, polyether ether ketone, and polypropylene 3D build materials.

### 3D Printing Process

The 3D printing process, using a support polymer, includes the co-printing of the support material and the build material, followed by the removal of the support material.

The 3D printing machine used must be able to selectively deposit both the support and the build material compositions, either through the use of multiple nozzles, or a single nozzle with a material multiplexer setup that allows multiple materials be extruded using the same nozzle, or both. Such machine could be any know machine falling within the definition for material extrusion or a hybrid system that contains one or more material extrusion heads according to ASTM F2793.

As used herein, the term “support” describes any geometry that is intended to be removed from the object before it can be considered complete. Support structures may either be procedurally generated by software or manually designed and added to the model. The support need not be printed entirely with one material. In one embodiment, a three material 3D printer could be used to print the initial support from a strong rigid material that is optimized for quick printing, while the support interface material that contacts the build material object could be optimized for its solubility and compatibility to the main build material. Any of the support materials can be of the support polymer composition described above.

Furthermore, support material could consist of an infinitesimally varied mixture of two or more feedstocks (filaments, pellets, etc.) that are actively blended within the nozzle, resulting in the acrylic support composition.

The support structure of the invention can be used for a variety of purposes. In one embodiment, a support is used when printing structures that branch out and overhang from the model or bridge over long distances by providing a support structure that allows the fluoropolymer to be printed in its desired shape without falling or drooping and have a change in dimension. In addition, a support is used when printing sharp angles (<45 or <30 degree from the glass plane) with the model material and wanting to keep it's desired shape without drooping.

In another embodiment, the support is used to improve the quality of printing by providing structures that catch material oozing from the nozzle. In another embodiment, supports are used to increase adhesion to the build surface and combat the tendency of the build material to shrink and deform during cooling. A support structure can also serve to protect delicate elements of a model. A support may also be a structure that aids in post processing or acts as some form of sacrificial tooling during post processing and assembly. A support may also be used to mark or write letters, numbers, QR codes, or other identifying symbols on the surface of the model. The support composition may be also be used for a combination of one or more of the reasons above.

For a composition to function as a support, it must adhere to the main build composition. In a preferred embodiment, the support material would adhere to the build material regardless of the order in which they are printed. While not being bound by any particular theory, it is believed that compatible, miscible and semi-miscible material compositions have better adhesion to the build material.

For example, PVDF can be printed onto PVA, but PVA cannot be printed onto PVDF due to a combination of the low compatibility between the materials and the differences in processing temperatures between the two materials. As it's extruded from the nozzle, the PVA does not have the thermal energy required to re-melt the PVDF surface. The acrylic copolymer composition and the PMMA-PLA alloy that have been tested were able to be printed onto PVDF and have PVDF printed onto them. The ability to switch back and forth between materials allows for more complex geometries. In addition, it should be noted that while PVDF does not stick to PLA well, cannot be printed on PLA, and is not compatible with PLA, it does stick to the PMMA-PLA alloy and can be printed on the alloy and is compatible with the alloy.

Generally, one would first print a raft on a glass plate for the first few layers using just the support polymer composition, followed by printing the 3D object. As the build material is printed, the support scaffolds are printed as needed to support the object.

Following the printing of the object and the support, the support material is removed.

For removing the support following printing, there several choices, including but not limited to:
a) Physical removal. Small gaps may be printed between the support and the printed object—in a sense like adding perforations between the support and the object. Gaps of 0.2 mm or larger can be used. This gap makes it possible to break off the support layer—also called the breakaway support. This method provides less beneficial warpage reduction, due to a non-continuous support. A variation is to print the final support contact layer extremely thin, but continuous, with a similar limited support of the printed object, and less warpage reduction. Another means of physical removal is to use a sharp object, like a knife to remove the support material.
b) Dissolution of the support material. This method involves no gap, or extremely thin gap between the contact layers, and thus provides increased support. The support layer can then be either dissolved, or softened or swelled and then broken away, using a solvent, such as, but not limited to xylene, ethyl acetate and toluene. Since the fluoropolymer object is more chemical resistant than the acrylic support, it is possible to dissolve out the support layer without affecting the printed object, and is known as a soluble support. This more complete contact between support and build layers leads to better adhesive support—and thus less warpage results.

In a preferred embodiment, the support composition is selected to allow for dissolution using mild solvents, such as alcohols, cold or warm water, or aqueous alkaline or acidic solutions. In one embodiment, an acrylic polymer support may be synthesized to include functional monomer units, such as acid monomers, that are hydrophilic, and soluble in an alkaline solution.

Once the polymer matrix of the support material is selected to be compatible, miscible or semi-miscible with the build material, other additives may be added into the support material composition to help with the dissolution of the support polymer composition. These include small water-soluble polymer particles—like PVA and PVOH, soluble salts, or other soluble materials. In another embodiment, a highly compatible and miscible with the build material acrylic can be added to a less compatible with the build material but dissolvable using mild solvents polymer to improve its compatibility with the build material.

In one embodiment, a support material could be used that has weaker bonding to the build material, can be easier to remove—but also provides an intermediate level of warpage reduction. An example would be a PLA/PMMA blend.

In the 3D printing process of a support material, it is important to for the support material to have some stiffness, to support the build layer. In one preferred embodiment, a fan is used to cool the support layer, for a faster development of stiffness. It is preferred that the support layer has a greater than or equal stiffness (modulus), to that of the build material.

This acrylic copolymer support material has been found to be effective with both homopolymer and copolymer PVDF printable resins in addition to both filled and unfilled PVDF resins. For the best warpage reduction, the PVDF is printed on a solid layer of acrylic copolymer with no gap in the Z direction. In the no-gap print, the acrylic copolymer layer is removed by dissolution. If less warp reduction is acceptable, a 0.2 or roughly one layer height gap in the Z direction is used to allow for easier breakaway of the support afterwards—overhangs are still supported well, but the supports are easily broken away.

In one embodiment, the acrylic copolymer of the invention was employed as both the support and base raft. It was found that the warpage of the PVDF object was reduced by over half, and parts can be printed over twice as long or twice as tall before warpage.

### EXAMPLES

Glass transition temperature (Tg) is determined by DSC according to standard ISO 11357-1: 2009 and ISO 11357-2 and 3: 2013, at a heating rate of 20 K/min.

### Example 1: Warping Test: Determination Compatible Support Compositions

The following test was used to measure the compatibility or incompatibility of a support layer and a build layer. During FFF 3D printing, each printed layer exerts a shear force on the previously printed layer as it cools causing the material to warp or curl. The semi-crystalline structure of polymers such as PVDF allows the polymer to maintain its rigidity past its glass transition temperature. The problem is further exacerbated by the shrinkage of the polymer that occurs as the polymer crystallizes. The main force that counteracts the warping effect of the polymer is the adhesion to the build surface or support structure. PVDF and other fluoropolymers have low adhesion to the glass and PEI build surfaces and high shrinkage due to crystallization which limits the size of parts that can be printed.

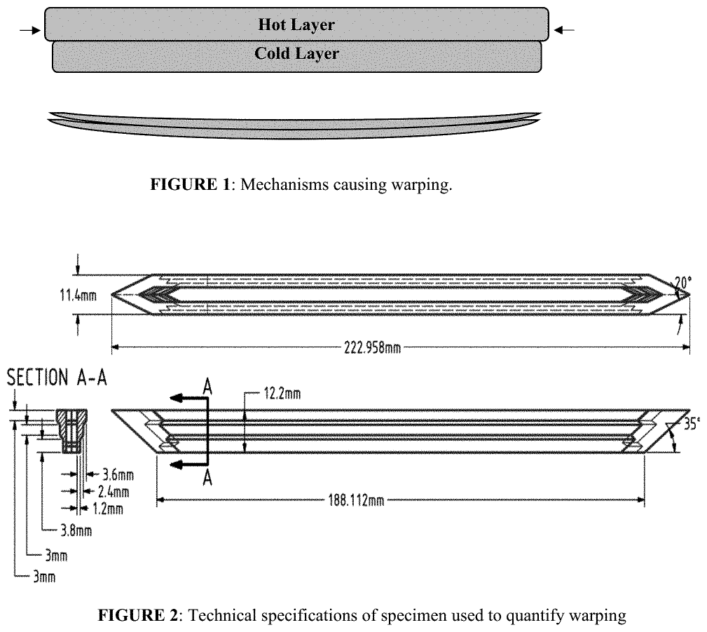

A test to quantify the warping of different polymers was developed as a general performance evaluation tool for comparing different polymer compositions. It features a specimen (FIG. 1) with a small surface area in contact with the build plate as well as well as sharp corners which tend to exacerbate warping. The cross sectional area of the specimen increases in the vertical, Z, direction, so the part is more challenging to print as the print continues. Different polymer compositions can be compared based on how much of the model the composition was able to print before the warping became so severe that the model released from the build plate. Materials that can complete the entire test are considered excellent when it comes to warping. (FIG. 2)

When printing with a secondary support material, the support material can act to improve the adhesion of the main material to the build plate.

Two different PVDF compositions were tested with compositions that span a range of commercially available PVDF based filaments. Each has some amount of alloying or copolymer present to reduce the warping caused by high shrinkage of PVDF upon cooling. Composition 1 has properties most similar to a PVDF homopolymer, but suffers from the highest degree of warping. This warping makes it the most challenging to support as it will easily peel away from the support substrate if the adhesion is insufficient. Composition 2 is a PVDF/HFP copolymer.

TABLE 1
Different PVDF based fluoropolymer compositions

| | | Warp test height | |
|---|---|---|---|
| | | completed on glass | |
| Composition name | Composition details | with PVA glue | |
| Filament made from | PVDF Acrylic Alloy | 1.2 | mm |
| Arkema Kynar ® | | | |
| 826-3D | | | |
| Composition 2 | PVDF HFP Copolymer | 6 | mm |
| | with 7-9% HFP | | |
| Composition 3 | PVDF HFP Copolymer | 10.8 | mm |
| | with 7-16% HFP alloyed | | |
| | with 50% PVDF | | |
| | homopolymer | | |

An acrylic based material will have better adhesion to glass than PVDF, and will adhere very well to PVDF due to its compatibility and miscibility with the material. A variety of support materials were tested with a PVDF material that features significant warping when printed on its own. These results can be seen in Table 1. The filament made from Kynar® 826-3D build material is only able to print 1.23 mm of the 12.2 mm specimen when not using a support interface. HIPS and ABS supports perform even worse than this baseline due to a lack of compatibility of said materials to the PVDF material, while PETG, PLA, and PVA allow for modest improvement. Surprisingly, Stratasys SR-30, an alkaline soluble acrylic containing support material did not adhere to PVDF. If this material contained more PVDF compatible acrylics, such as mentioned in this invention, it could support PVDF.

Only the PLEXIGLAS® 3DS acrylic copolymer composition and the PLEXIGLAS® RNEW® B514 PMMA-PLA alloy were able to significantly improve the warping performance of the PVDF material. The 3Diakon™ PMMA material itself exhibited a great amount of warping, which caused the entire raft to come loose from the bed when printed at the manufacturers recommended build plate temperature of 100 C. If this PMMA composition could be made to warp less and print better by modifying the composition or printing conditions it could be a viable support for PVDF. All of these tests were performed using a glass build surface coated with PVA glue on an Ultimaker S5 desktop 3D printer. It should be noted that all materials tested, except for the 3Diakon™ PMMA, have good printability and could print the full warping specimen when printed on their own.

TABLE 2
Composition 1 printed onto support rafts of different polymers

| | Height | | |
|---|---|---|---|
| Support Raft material | completed | | Mechanism of failure |
| PLEXIGLAS ® 3DS | 12.2 | mm | Completed full print: 3-4 |
| | | | mm of curl at end |
| PLEXIGLAS ® KNEW ® | 12.2 | mm | Completed with 4-5 mm of |
| B514 | | | warp |
| 3DIAKON ™ high warping | 5.4 | mm | Raft released from bed |
| acrylic copolymer | | | |
| Ultimaker PVA | 3.4 | mm | Peeled off of support layer |
| Ultimaker PLA | 2.8 | mm | Peeled off of support layer |
| Matterhackers PETG | 1.8 | mm | Peeled off of support layer |
| No Support Raft | 1.2 | mm | Released from bed |
| Stratasys ® SR-30 | 1 | mm | Peeled off of support layer |
| (Alkaline soluble | | | |
| acrylic blend) | | | |
| Ultimachine HIPS | 0.8 | mm | Peeled off of support layer |
| Ultimaker ABS | 0 | mm | Will not Stick |

Composition 2 Printed onto Various Support Rafts

| | Height | | |
|---|---|---|---|
| Support Raft material | completed | | Mechanism of failure |
| PLEXIGLAS ® 3DS | 12.2 | mm | Completed full print with |
| | | | 4-5 mm of curl |
| No Support Raft | 6 | mm | Released from bed |

Material providing a print height of greater than 4 mm, and preferably greater than 6 mm, and more preferably greater than 10 mm are considered to be compatible. Alternatively, materials providing a print height increase from just the build material itself of greater than 2 mm, 3 mm, 4 mm, preferably 5 mm where possible are considered to be compatible to the build material.

### Example 2: Layer Adhesion Strength Between Support Materials and PVDF

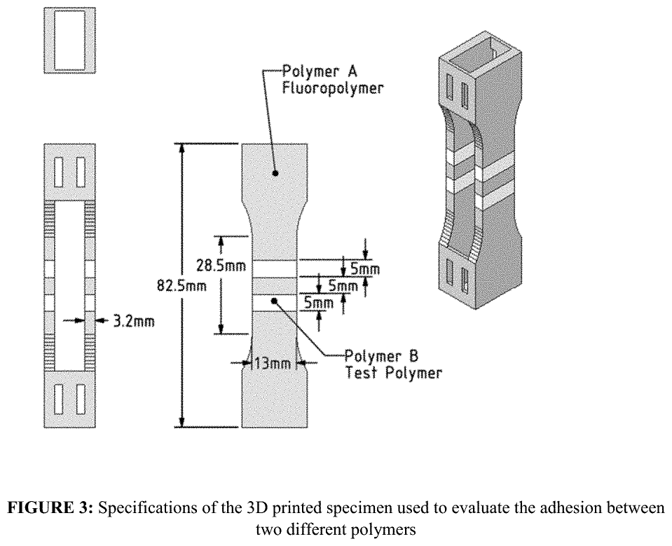

To quantify the adhesion between the dissimilar polymers a specimen was developed that alternated which material was printed (FIG. 1). This specimen was loosely based on standards such as AWS G1.6 and DVS 2203-5 which outline a method for testing the tensile strength of thermoplastic welds using a tensile dog bone with a spliced section in the middle of the gauge. The specimen developed was based off an ASTM D638 Type one specimen that has been made 50% shorter to decrease print time and increase the stability of the part during printing. Two Specimens are printed simultaneously and connected to create a specimen that will not topple over during printing. The material type switches within the gauge to create section order to test the bond strength of the material interfaces. The specimen features both PVDF to support interfaces and support to PVDF interfaces. (FIG. 3)

The results of testing (Table 3) show the significant adhesion between the acrylic based compositions and the PVDF alloy. The specimens showed failure points at both PVDF to acrylic composition and acrylic composition to PVDF suggesting relatively close bond strength between the two different transition types. The adhesion strength around 11 MPa is equivalent to an applied load of around 500N, which is strong enough to hold the weight of an object with 5 kg of mass. However, for the results using PVA filament, the specimen could not be printed as the PVA material is not able to print onto the PVDF material.

TABLE 3

| | Adhesion strength to PVDF | Strain at |
|---|---|---|
| Test Material | alloy (MPa) | break |
| PLEXIGLAS ® KNEW ® | 11.5 | 2.3% |
| B514 | | |
| PLEXIGLAS ® 3DS | 11.0 | 2.2% |
| PVA | Could not print specimen | N/A |

### Example 3: Using Acrylic Based Materials to Support Other Compatible Materials

Other materials were also tested for adhesion to an acrylic substrate. PEBAX®, a poly(ether-block-amide), with good printability and compatibility with other supports such as PVA was able to complete the full 12.2 mm of the warp test from Example 1 when printed onto the PLEXIGLAS® 3DS support material. A higher Tg acrylic copolymer (Tg of 90-92 C) was tried as a support material for PEKK (Tg of 160 C. This was also completed, but with 6-7 mm of curl at the ends. The curl was caused by the acrylic copolymer being too soft as the printing conditions for PEKK is at least 110-120° C. of buildplate temperature. An acrylic based composition with a higher Tg would be able to better support PEKK as the materials adhere very well to each other.

### Example 4

A 3D supported object is printed using PLEXIGLAS® 3DS as the support material. A PVDF copolymer blend is used as the build material. The support settings were selected to be between a breakaway and soluble support, with a raft and solid top, with 0-1 layer gap between the support and build material. The build plate is first heated to 70°-100° C. The PLEXIGLAS® 3DS is printed at 240° C., PVDF is at 260° C. No heated chamber is needed.

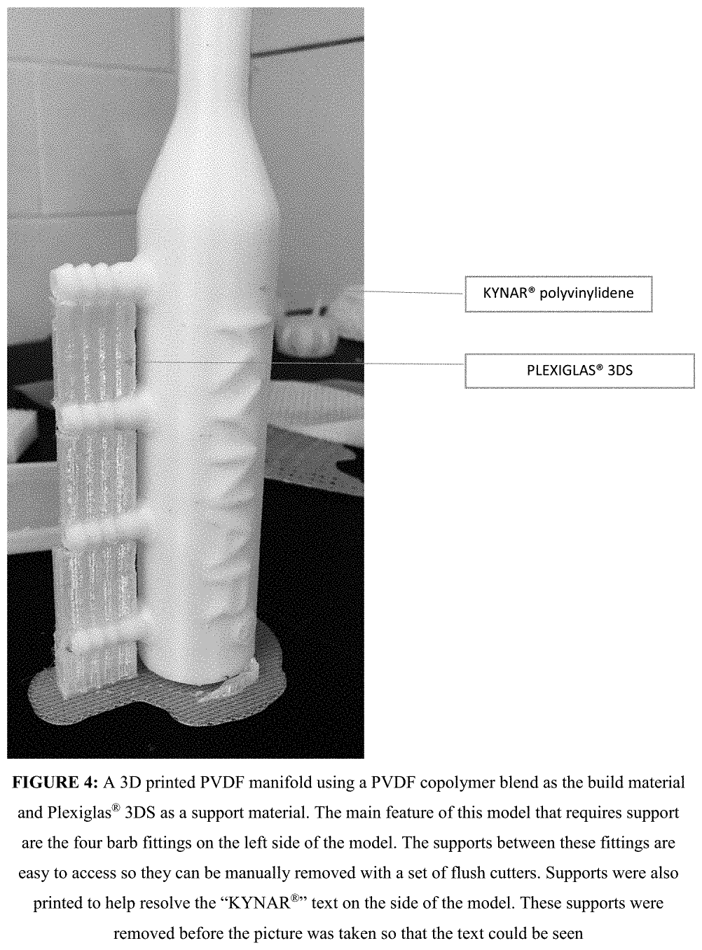

The object printed, with the support structure intact, is shown in FIG. 4.

### Example 5: Using Acrylic Supports with Arkema 826-3D Resin

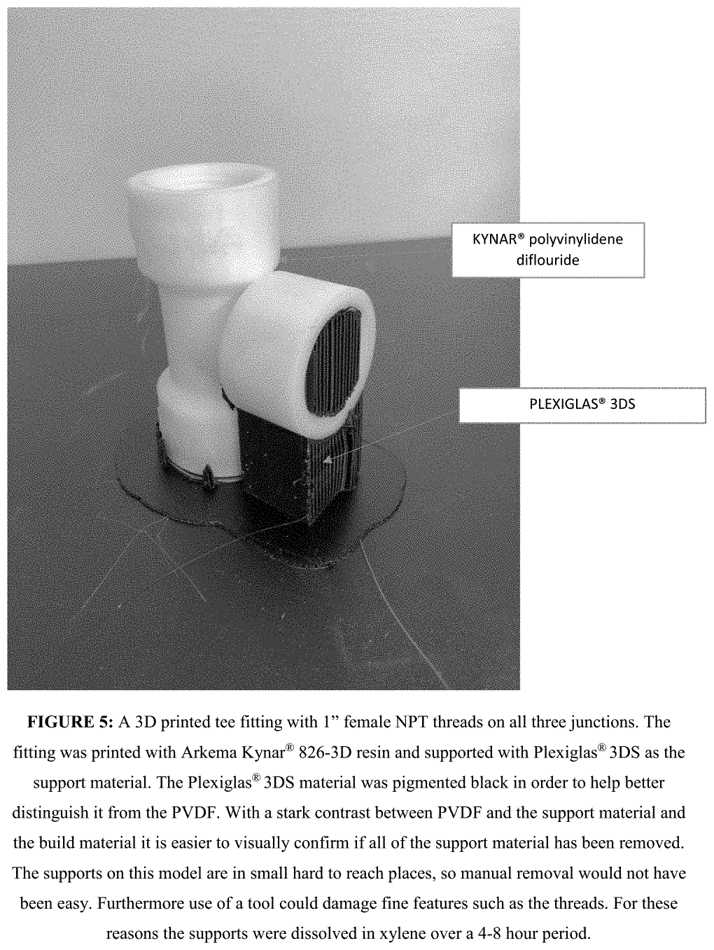

Another example part can be seen in FIG. 5 which feature a pipe fitting printed with Arkema Kynar® 826-3D resin and the PLEXIGLAS® 3DS support material in Example 4, but with a pigment added to PLEXIGLAS® 3DS to make it appear black. This part demonstrates the complexities that can be achieved with a with a well suited support material such as internal threads in any plane of the part. The design of the part also requires both the build material to be printed onto the support material and the support material to be printed onto the built material. The acrylic copolymer was able to make these transitions successfully. The supports featured here were dissolved in Xylene, which is a good solvent of acrylic copolymers, but does not affect PVDF. The Xylene bath was agitated and the supports were fully dissolved over a period of 4-8 hours. Once the supports were dissolved the 1″ NPT female threads were able to function with other 1″ NPT male threaded parts.

1. A support material composition for 3D printing of polyamide (PA), polyether-block polyamides (PEBA), polyether ether ketone, polyether ketone ketone (PEKK), and fluoropolymer compositions, wherein said support material composition comprises one or more polymer compositions compatible, miscible or semi-miscible with said PA, PEBA, PEEK, PEKK or fluoropolymer composition.

2. The support material composition of claim 1, wherein said compatible polymer composition comprises a matrix polymer selected from the group consisting of acrylics, polyesters, and polycarbonate.

3. The support material composition of claim 1, wherein said support is an acrylic composition.

4. The support material composition of claim 3, wherein said acrylic composition is selected from the group consisting of acrylic copolymers, acrylic alloys, and acrylic polymers blended with non-polymeric additives.

5. The support material composition of claim 3, wherein said acrylic composition has a Tg of less than 165° C., and wherein said Tg is above room temperature.

6. The support material composition of claim 3, wherein said acrylic composition has a low shear rate viscosity as measured at 4 sec⁻¹ of less than 100,000 Pa-s by capillary rheometry according to ASTM C₉₆₅, at a temperature of 230° C.

7. The support material composition of claim 3, wherein said acrylic composition has a high shear rate viscosity of 30 to 2000 Pa-s at 232° C. and 100 sec⁻¹, as measured by capillary rheomometry at the temperature given in the ASTM Melt Flow Testing for that fluoropolymer.

8. The support material composition of claim 3, wherein said acrylic composition comprises at least 20 wt % of one or more (meth)acrylic polymers, wherein said (meth) acrylic polymer comprise polymethyl methacrylate homopolymer or copolymer containing at least 51 wt % of methyl methacrylate monomer units.

9. The support material of claim 8, wherein said miscible polymer is an acrylic copolymer, which comprises at least 20 weight percent of the support material composition.

10. The support material composition of claim 3, wherein said acrylic composition comprises a copolymer comprising from 70 to 80 weight percent of methyl methacrylate monomer units, and from 20 to 30 weight percent of C₁₋₄ acrylate units.

11. The support material of claim 3, wherein said acrylic composition is impact modified, having from 5-60 weight percent of impact modifiers.

12. The support material composition of claim 3, wherein said composition further comprises additives selected from the group consisting of stabilizers, plasticizers, fillers, coloring agents, pigments, antioxidants, antistatic agents, surfactants, toner, refractive index matching additives, additives with specific light diffraction or light reflection characteristics, lubricants, solubility enhancers, mechanical removal enhancers, and dispersing aids, and mixtures thereof.

13. The support material composition of claim 1, wherein said support material is soluble in a solvent selected from the group consisting of water, hot water, aqueous alkaline solution, and ethanol.

14. The support material composition of claim 1 wherein said support material composition comprises said fillers comprise polymers, salts and other compounds that are soluble in solvents selected from the group consisting of cold water, hot water, aqueous alkaline or acid solutions, ethanol, xylene, and toluene.

15. The support material of claim 1, wherein said fluoropolymer has a low shear rate viscosity at 232° C. and 4 sec⁻¹ of less than 13,000 Pa-s, as measured by capillary rheomometry, and a high shear rate viscosity of 30 to 2000 Pa-s at 232° C. and 100 sec⁻¹, as measured by capillary rheomometry at the temperature given in the ASTM Melt Flow Testing for that fluoropolymer.

16. The support material of claim 1, wherein said fluoropolymer comprises PVDF.

17. The support material of claim 1, wherein said fluoropolymer comprises PVDF blended with an acrylic polymer or copolymer, or a PVDF copolymer.

18. An acrylic support composition for 3D printing of an object, wherein said object composition comprises one or more polymers compatible, miscible or semi-miscible said acrylic-compatible composition.

19. The acrylic support material of claim 17, wherein said acrylic compatible polymer is a polyvinylidene fluoropolymer or copolymer.

20. A process for printing a 3D object using a support material composition and a build material, comprising the step of printing both the 3D build material and support material, wherein said support material is compatible, miscible or semi-miscible with a fluoropolymer build material, and the step of removing the support material composition after formation of the 3D printed object.

21. The process of claim 19, wherein removal of the support material occurs due to a physical breaking or dissolution of the support material.

22. The process of claim 20, wherein said dissolution step comprises the step of dissolving the support material in a solvent selected from xylene, toluene, cold water, hot water, ethanol, aqueous alkaline solution, and aqueous acid solution.

23. The support material composition of claim 3, wherein said acrylic composition comprises a blend of a methacrylate copolymer and polylactic acid polymer.
